(19) United States
(12) Patent Application Publication
(10) Pub. No.: US 2008/0240473 A1
(43) Pub. Date: Oct. 2, 2008

(54) SPEAKER CONE ASSEMBLY FOR PREVENTING THE INTRUSION OF MOISTURE AND METHOD OF FORMING SAME

(75) Inventors: Michael J. Maxim, Boca Raton, FL (US); Jorge L. Garcia, Plantation, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/694,768

(22) Filed: Mar. 30, 2007

(51) Int. Cl. H04R 1/00

(52) U.S. Cl. 381/189

(57) ABSTRACT

A speaker cone assembly (200) used in an electronic device includes a speaker basket frame (201) and a cone (203) for covering a top surface of the speaker basket (201). The cone (203) includes a downward facing lip (216) for radially sealing the perimeter edge (207) of the cone (203) with the housing (235). A flexible circular insert (225) extends around the perimeter edge (207) for reducing the amount of moisture contacting the downward facing lip (216). The speaker basket (207) includes a mounting channel (218) where the circular seal (225) includes a radial channel (233) that engages with the mounting channel (218) for preventing moisture from propagating under the speaker basket frame (201).

### FIELD OF THE INVENTION

The present invention relates generally to speakers used in connection with electronic devices and more particularly to speaker cones used with the speaker assembly that work to prevent water damage.

### BACKGROUND

Internal speakers are used in many types of portable electronic devices such as two-way radio transceivers for transducing speech and providing audible sounds. FIG. 1 illustrates a prior art diagram of a standard speaker assembly 100 having a speaker basket 101 and speaker cone 103. Those skilled in the art will recognize that the speaker cone vibrates to produce auditory sounds but also operates to create a seal or barrier to prevent water, dust, or other debris from contacting the operational assembly of the speaker. The problem with many speakers when used with portable type devices occurs when the device gets wet or is submerged in water. Under these circumstances, the standard speaker assembly has multiple sites for moisture intrusion. Most speakers used in portable devices are not designed to be watertight when enclosed within the device's housing but instead include compression seals that work to prevent water entry.

As best seen in FIG. 1, a forward facing lip 102 is typically held to the speaker basket using a compression type seal. To be effective, the compression seal requires that a substantially large load be placed on the speaker basket 101. This load can cause plastic relaxation or “creep” that untimely works to compromise the compression and/or seal force. In turn, its use requires use of thicker basket walls which will increase the overall size and expense of the speaker assembly. Moreover, adhesives used with the compression seal are often used as a sealing component and are also susceptible to water intrusion. Once water breaches the adhesives and speaker cone, the electronics can be damaged or disabled entirely.

FIG. 2 illustrates a cross-sectional view of an alternative embodiment as used in the prior art. The speaker basket 101 and speaker cone 103 are illustrated where the outer perimeter of the speaker cone 103 includes a raised edge 105 and a flat edge 107. The flat edge 107 engages under a silicone seal 109 which is positioned adjacent to an upward facing basket lip 111 and raised support surface 113. Although adhesives are used to seal the flat edge 107 of the speaker cone 103, water may still penetrate under the housing 104 and flat edge 107 which can affect speaker operation.

Similarly, FIG. 3 illustrates a cross-sectional view of an alternative embodiment where the raised edge 105′ of the speaker cone 103′ is used in connection with an upper pressure seal 115 and lower pressure seal 117. The lower pressure seal 117 lies on the raised support surface 113′ to hold the flat edge 107′ into a fixed position. This embodiment also can be problematic since water can get under the housing 104 to breach the upper pressure seal 115, the lower pressure seal 117 and/or speaker cone 103′ rendering the speaker inoperative.

Consequently, the need exists to provide a cone and seal assembly for protecting the speaker from water intrusion while residing within an electronic device housing. The speaker assembly should form a substantially impermeable seal that does not require adhesives or large compressive loads to be effective against water intrusion.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a perspective view illustrating a standard speaker assembly as used in the prior art.

FIG. 2 is a magnified cross-sectional view illustrating a standard speaker assembly like that shown in FIG. 1.

FIG. 3 is a magnified cross-sectional view illustrating an alternative speaker assembly as used in the prior art.

FIG. 4 is a front perspective view illustrating a speaker and speaker cover with waterfall edge in accordance with an embodiment of the invention.

FIG. 5 is a magnified view of the edge of the speaker basket and cover as shown in FIG. 4.

FIG. 6 is a magnified cross-sectional view of the speaker basket and cover as shown in FIG. 4.

FIG. 7 is front perspective view of a flexible insert for use in providing a perimeter seal around the speaker basket and cover.

FIG. 8 is a magnified cross-sectional view of the flexible insert as shown in FIG. 5.

FIG. 9 is a magnified cross-sectional view of the speaker cone assembly for preventing the intrusion of water in accordance with an embodiment of the invention.

FIG. 10 is a top perspective view of the seal assembly as used in connection with an electronic device housing in accordance with an embodiment of the invention.

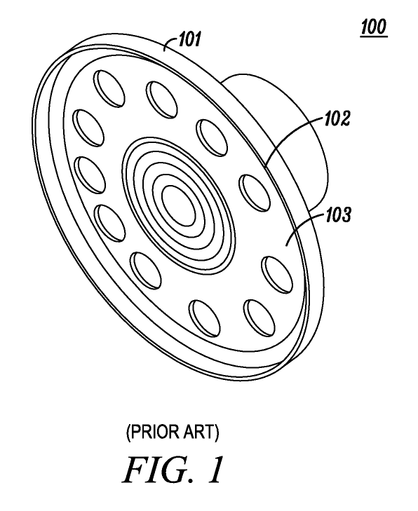

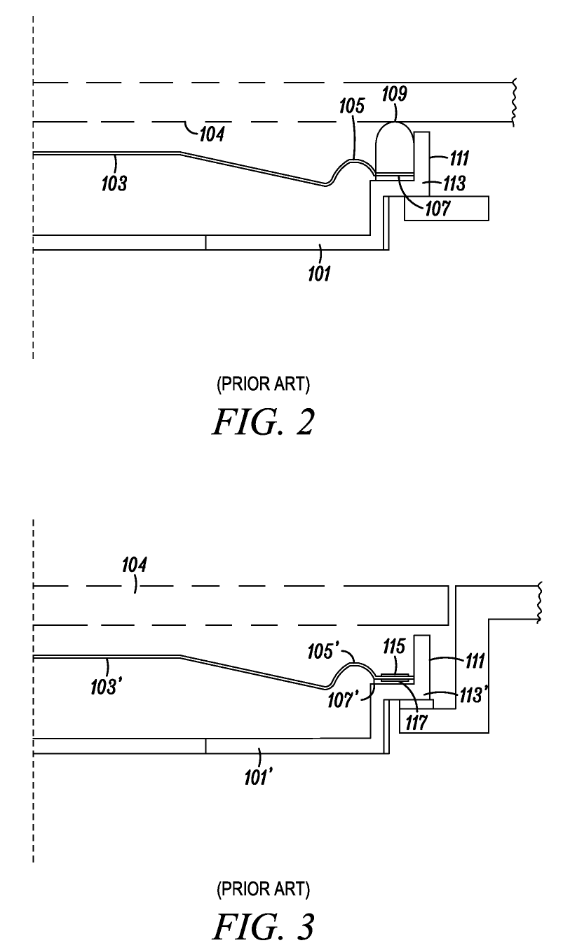

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a speaker cone and seal assembly. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

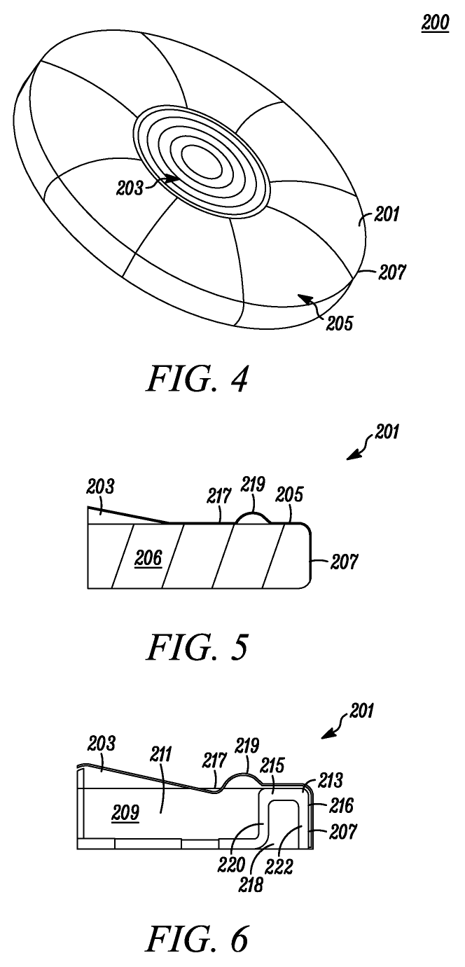

FIG. 4 is a front perspective view illustrating a speaker cone and seal assembly 200 in accordance with an embodiment of the invention. The assembly 200 includes a speaker basket frame 201 and speaker cone 203 for transducing energy into an audible form. The cone 203 may be manufactured of a thin paper or plastic material that is impervious to water. The cone 203 is shaped and configured so as to extend over both a flat edge 205 and perimeter edge 207 of the speaker basket frame 201. It will be recognized by those skilled in the art that the terms water and/or moisture may be used interchangeably herein.

FIG. 5 illustrates a magnified view of the perimeter edge 207 of the speaker basket frame 201 and speaker cone 203 as shown in FIG. 4. The speaker cone 203 extends over the flat edge 205 and downwardly around the perimeter edge 207 so to allow radial sealing between the speaker cone 203 and the radial surface 206 of the speaker basket frame 201. A groove 217 operates in combination with radius 219 to prevent water outside of the radius 219 from entering through the speaker cone 203.

FIG. 6 is a magnified cross-sectional view of the speaker basket frame 201 and speaker cone 203. The cross-sectional view of the speaker basket frame 201 reveals a cavity 209 where an inner side 211 extends radially about the perimeter edge 207 of the speaker basket 201. The inner side 211 forms a raised channel 213 having a flat surface 215. As seen in both FIGS. 5 and 6, the edge of the cone 203 includes a groove 217 extending to a radius 219 that further extends into the flat surface 215 to form a downward facing lip 216. Although not seen in FIG. 5, FIG. 6 illustrates the groove 217 extending below the radius 219 into cavity 209. In operation, this downward facing lip 216 works to prevent water from entering through the flat surface 215 due to the radial seal along the perimeter edge 207. A mounting channel 218 is formed under the raised channel 213 by inner wall 220 and outer wall 222 and is substantially inverted U-shaped in cross section relative to the downward facing lip 216. Both inner wall 220 and outer wall 222 form a plurality of parallel walls joined by the flat surface 215.

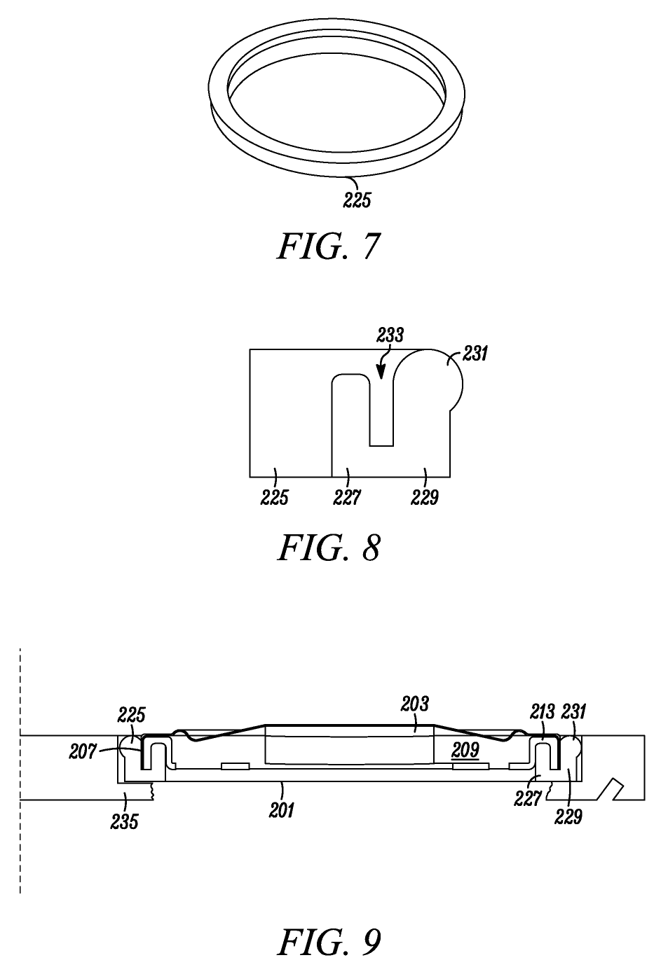

FIG. 7 is front perspective view of a flexible insert 225 for use in providing a seal around the speaker basket. In order to provide a better watertight seal around the raised channel 213 of the perimeter edge 207, the flexible insert 225 helps to prevent water from entering the cavity 209. FIG. 8 is a magnified cross-sectional view of the flexible insert as shown in FIG. 7. The flexible insert 225 is substantially circular and preferably made from a pliable material such as silicon rubber or the like. A cross-sectional edge of the flexible insert 225 includes a first wall 227 and a second wall 229 having a rounded head 231. Between the first wall 227 and the second wall 229, a radial channel 233 is used to help in sealing the flat edge 205 of the speaker basket frame 201 as shown in FIG. 5.

FIG. 9 is a full cross-sectional view of the speaker cone assembly for preventing the intrusion of water in accordance with an embodiment of the invention. Thus, speaker assembly formed in accordance with the invention prevents the intrusion of moisture through the use of the speaker basket frame 201 including the raised channel 213 of the speaker cone 203 extending over the perimeter edge 207 of the speaker basket frame 201. The flexible insert 225 includes a rounded head 231, first wall 227 and second wall 229 that engage with both portions of the speaker basket frame 201 and housing 235 for holding the speaker basket frame into a fixed position. This structure works in combination with the unique shape and configuration of the cone 203 for preventing water from entering both under the speaker cone 203 or into the cavity 209 under a bottom surface of the speaker basket frame 201. The invention works to prevent damage to both the speaker and the electronic components in the electronic device by blocking water or other liquids when completely submersed.

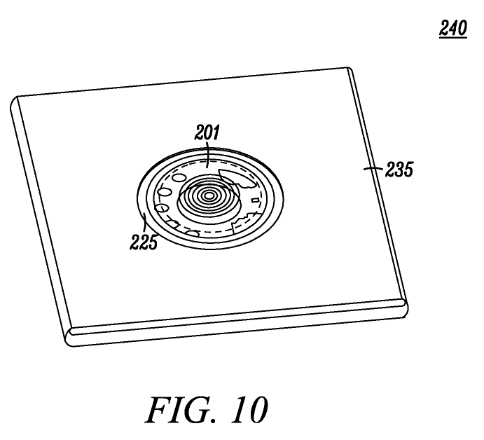

Finally, FIG. 10 is a top perspective view of the seal assembly as used in connection with a housing 235 in accordance with an embodiment of the invention. In the completed final assembly of the electronic device 240, the speaker cone and seal assembly 200 works to prevent water from entering the housing 235. This allows the speaker to be substantially impervious to water and/or other moisture when submerged without operational damage to the electrical contents.

Accordingly, there has been provided a speaker assembly for transducing audio in an electronic device. By providing a speaker basket having a mounting channel extending about the perimeter of the basket and covering the speaker basket with a speaker cone formed to include a downward facing lip around the perimeter of the speaker cone, a seal is created around the perimeter of the speaker basket for preventing the entry of moisture. The prevention of moisture intrusion is further enhanced by utilizing a circular seal extending around the speaker basket.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A speaker cone assembly used in an electronic device comprising:
a speaker basket;
a cone for covering a top surface of the speaker basket; and
wherein the cone includes a downward facing lip for radially sealing the perimeter of the cone against the speaker basket.

2. A speaker cone assembly as in claim 1, further comprising a circular seal extending around the speaker basket for reducing the amount of water contacting the downward facing lip.

3. A speaker cone assembly as in claim 2, wherein the speaker basket includes a mounting channel having a plurality of parallel walls joined by a raised surface.

4. A speaker cone assembly as in claim 3, wherein the circular seal includes a radial channel that engages a portion of the mounting channel for preventing moisture from propagating under the speaker basket.

5. A speaker cone assembly as in claim 1, wherein the cone includes a groove for preventing moisture from entering beneath the cone.

6. A speaker cone assembly as in claim 1, wherein the speaker cone assembly is used in a two-way radio transceiver.

7. A speaker assembly for use with an electronic device comprising:
a speaker basket frame including a mounting channel for use with an audio speaker;
a speaker cone sized to cover the speaker basket frame;
a circular seal extending about the perimeter of the speaker basket frame and engaging with the mounting channel for preventing moisture from entering beneath the speaker basket frame; and
wherein the speaker cone includes a downward facing edge for radially sealing the perimeter of the speaker cone with the speaker basket frame.

8. A speaker assembly as in claim 7, wherein the circular seal includes a radial channel for engaging with the mounting channel to hold the seal in a fixed position with the basket frame.

9. A speaker assembly as in claim 8, wherein the radial channel is formed using a first wall and second wall extending about a perimeter of the seal.

10. A speaker assembly as in claim 7, wherein the mounting channel is formed using an inner wall and outer wall joined by a flat surface.

11. A speaker assembly as in claim 7, wherein the speaker cone includes a groove for preventing moisture from entering beneath the speaker cone.

12. A speaker assembly as in claim 7, wherein the electronic device is a two-way radio transceiver.

13. A method for forming a speaker assembly for use transducing audio in an electronic device comprising the steps of:
utilizing a speaker basket having a mounting channel extending about the perimeter of the basket;
covering the speaker basket with a speaker cone for preventing the entry of moisture; and
forming downward facing lip around the perimeter of the speaker cone for creating a seal around the perimeter of the speaker basket.

14. A method for forming a speaker assembly as in claim 13, further comprising the step of:
forming the mounting channel in the speaker basket using a plurality of parallel walls joined by a raised surface.

15. A method for forming a speaker assembly as in claim 14, further comprising the step of:
forming a circular seal extending around the speaker basket.

16. A method for forming a speaker assembly as in claim 15, further comprising the step of:
forming a rounded edge on the circular seal for engaging with a portion of a housing of the electronic device.

17. A method for forming a speaker assembly as in claim 15, further comprising the step of:
forming the circular seal with a bottom surface for preventing water from entering upper the speaker basket frame.

18. A method for forming a speaker assembly as in claim 17, further comprising the step of:
forming a radial channel around the circular seal to engage a portion of the mounting channel for preventing moisture from propagating under the speaker basket.

19. A method for forming a speaker assembly as in claim 13, wherein the electronic device is a two-way radio transceiver.

20. An audio speaker assembly, comprising:
a speaker basket having an inverted substantially U-shaped perimeter edge, the U-shaped perimeter edge providing a mounting channel;
a speaker cone having a downward facing lip for coupling over the inverted U-shaped perimeter edge; and
a radial seal having a radial channel, the radial channel for coupling to the mounting channel of the speaker basket thereby sealing the downward facing lip of the speaker cone.

21. The audio speaker assembly of claim 20, wherein the speaker cone includes an outer edge, the outer edge forming a groove portion extending into a radius portion, the radius portion extending into a substantially flat surface, the flat surface leading into the downward facing lip.

22. The audio assembly of claim 21, wherein the speaker cone and speaker basket form a cavity therebetween, the cavity being sealed by the flat surface and downward facing lip of the speaker cone in conjunction with the inverted U-shaped perimeter edge of the speaker basket.
